(19) United States
(12) Patent Application Publication
(10) Pub. No.: US 2017/0039508 A1
(43) Pub. Date: Feb. 9, 2017

(54) SYSTEMS AND METHODS FOR RECOMMENDATION TOOL

(71) Applicant: Wal-Mart Stores, Inc., Bentonville, AR (US)

(72) Inventors: Joshua Neal French, Lowell, AR (US); Forest Denger, Fayetteville, AR (US); Michael Scott Williams, Bentonville, AR (US); Anita B. Montgomery, Fayetteville, AR (US); Zhiyuan Peng, Bentonville, AR (US); Ryan Tiemeyer, Bentonville, AR (US); Anitha Voruganti, Bentonville, AR (US); Carrie Henderson, Bentonville, AR (US); Kan Yao, Fayetteville, AR (US); Johnathon R. Shuler, Springdale, AR (US)

(21) Appl. No.: 15/226,073

(22) Filed: Aug. 2, 2016

Related U.S. Application Data
(60) Provisional application No. 62/200,477, filed on Aug. 3, 2015.

(51) Int. Cl. G06Q 10/06; G06Q 10/04; G06Q 10/10

(52) U.S. Cl. CPC G06Q 10/063118; G06Q 10/1097; G06Q 10/04; G06Q 10/1053

(57) ABSTRACT

Exemplary embodiments are provided for generating a metric based on current information and future needs. Historical payroll metrics are determined for a job title, and future payroll metrics are estimated for the job title. Forecasted workforce metrics are estimated for the job title, and preferred workforce metrics are determined for a specified period of time for the job title. It is determined whether a low-point is expected within the specified period. The forecasted workforce metrics and the preferred workforce metrics are compared to estimate an employee-hour deficit in the workforce. A hiring recommendation is generated based on the employee-hour deficit and open requisitions, and an employee status is assigned to the recommendation based on the low-point.

### RELATED APPLICATION

This application claims priority to U.S. Provisional Patent Application No. 62/200,477 filed on Aug. 3, 2015, which is hereby incorporated by reference in its entirety.

### BACKGROUND

Stores often struggle to meet budget and workforce goals, especially in a variable sales and customer demand environment. To manage a store in such an environment, the stores have to hire new employees judiciously to fulfill the task goals of the store. However, there is no efficient process available to aid a store to aid in effectively managing its hiring needs. Store managers usually have to access multiple systems for information regarding budget and current employees, and manually determine whether a new employee is affordable or needed.

### SUMMARY

In one embodiment, a method for generating a hiring metric based on current workforce information and future workforce needs is provided. The method includes determining, by a payroll module, historical payroll metrics for a job title associated with a specified store based on programmatic execution, by the payroll module, of a first algorithm that receives as inputs payroll data for employees working at the specified store with the job title including a number of hours worked and a present number of employees with the job title that are employed by the specified store. The method further includes estimating, by the payroll module, future payroll metrics for the job title based on a programmatic execution, by the payroll module, of a second algorithm that receives as inputs a forecasted number of employees to hold the job title at the specified store and a forecasted number of hours for which employees with the job title are scheduled to work at the specified store, including full-time employees and part-time employees. The forecasted number of employees is based on adjusting the present number of employees with the job title by an attrition rate at the store for employees with the job title, and the forecasted number of hours employees with the job title are to be scheduled is based on a full-time or part-time status of the employee and addition of paid holidays. The method also includes estimating, by a workforce module, forecasted workforce metrics for the job title based on execution, by the workforce module, of a third algorithm that receives as inputs the future payroll metrics, a work schedule for the employees at the specified store with the job title, and a number of open requisitions for the job title for the specified store. The method also includes determining, by the workforce module, preferred workforce metrics for a specified period of time for the job title including a preferred number of employees and a number of goal hours indicating employee-hours that need to be worked to fulfill one or more tasks assigned to the job title, and determining, by the workforce module, whether an anticipated low-point in customer demand curve is expected within the specified period of time. The method further includes comparing, by the workforce module, the forecasted workforce metrics to the preferred workforce metrics to estimate an employee-hour deficit in workforce during the specified time period, and generating, by a recommendation module, a hiring recommendation for the job title based on the estimated employee-hour deficit and open requisitions for the job title where the hiring recommendation indicates a proposed work schedule for a new-hire. The method also includes programmatically assigning, by the recommendation module, an employee status of full-time, part-time, or temporary to the hiring recommendation based on execution, by the recommendation module, of conditional code which considers a temporal relationship between the estimated employee-hour deficit and the identified low-point in the customer demand curve.

In another embodiment, a system for generating a hiring metric based on current workforce information and future workforce needs. The system includes a memory and a processor configured to execute instructions stored in the memory and causing the system to determine historical payroll metrics for a job title associated with a specified store based on programmatic execution of a first algorithm that receives as inputs payroll data for employees working at the specified store with the job title including a number of hours worked and a present number of employees with the job title that are employed by the specified store. The processor further causing the system to estimate future payroll metrics for the job title based on a programmatic execution of a second algorithm that receives as inputs a forecasted number of employees to hold the job title at the specified store and a forecasted number of hours for which employees with the job title are scheduled to work at the specified store, including full-time employees and part-time employees. The forecasted number of employees is based on adjusting the present number of employees with the job title by an attrition rate at the store for employees with the job title, and the forecasted number of hours employees with the job title are to be scheduled is based on a full-time or part-time status of the employee and addition of paid holidays. The processor further causing the system to estimate forecasted workforce metrics for the job titles based on execution of a third algorithm that receives as inputs the future payroll metrics, a work schedule for the employees at the specified store with the job title, and a number of open requisitions for the job title for the specified store, and determine preferred workforce metrics for a specified period of time for the job title including a preferred number of employees and a number of employee-hours that need to be worked to fulfill one or more tasks assigned to the job title. The processor also causing the system to determine whether an anticipated low-point in customer demand curve is expected within the specified period of time, and compare the forecasted workforce metrics to the preferred workforce metrics to estimate an employee-hour deficit in workforce during the specified time period. The processor further causing the system to generate a hiring recommendation for the job title based on the estimated employee-hour deficit and open requisitions for the job title, where the hiring recommendation indicates a proposed work schedule for a new-hire, and programmatically assign an employee status of full-time, part-time, or temporary to the hiring recommendation based on execution of conditional code which considers a temporal relationship between the estimated employee-hour deficit and the identified low-point in the customer demand curve.

In yet another embodiment, a non-transitory machine-readable medium is provided storing instructions executable by a processing device, where execution of the instructions causes the processing device to implement a method for generating a hiring metric based on current workforce information and future workforce needs. The method includes determining, by a payroll module, historical payroll metrics for a job title associated with a specified store based on programmatic execution, by the payroll module, of a first algorithm that receives as inputs payroll data for employees working at the specified store with the job title including a number of hours worked and a present number of employees with the job title that are employed by the specified store. The method further includes estimating, by the payroll module, future payroll metrics for the job title based on a programmatic execution, by the payroll module, of a second algorithm that receives as inputs a forecasted number of employees to hold the job title at the specified store and a forecasted number of hours for which employees with the job title are scheduled to work at the specified store, including full-time employees and part-time employees. The forecasted number of employees is based on adjusting the present number of employees with the job title by an attrition rate at the store for employees with the job title, and the forecasted number of hours employees with the job title are to be scheduled is based on a full-time or part-time status of the employee and addition of paid holidays. The method also includes estimating, by a workforce module, forecasted workforce metrics for the job title based on execution, by the workforce module, of a third algorithm that receives as inputs the future payroll metrics, a work schedule for the employees at the specified store with the job title, and a number of open requisitions for the job title for the specified store. The method also includes determining, by the workforce module, preferred workforce metrics for a specified period of time for the job title including a preferred number of employees and a number of goal hours indicating employee-hours that need to be worked to fulfill one or more tasks assigned to the job title, and determining, by the workforce module, whether an anticipated low-point in customer demand curve is expected within the specified period of time. The method further includes comparing, by the workforce module, the forecasted workforce metrics to the preferred workforce metrics to estimate an employee-hour deficit in workforce during the specified time period, and generating, by a recommendation module, a hiring recommendation for the job title based on the estimated employee-hour deficit and open requisitions for the job title where the hiring recommendation indicates a proposed work schedule for a new-hire. The method also includes programmatically assigning, by the recommendation module, an employee status of full-time, part-time, or temporary to the hiring recommendation based on execution, by the recommendation module, of conditional code which considers a temporal relationship between the estimated employee-hour deficit and the identified low-point in the customer demand curve.

In yet another embodiment, a system for generating a hiring metric based on current workforce information and future workforce needs is provided. The system includes means for determining historical payroll metrics for a job title associated with a specified store based on programmatic execution of a first algorithm that receives as inputs payroll data for employees working at the specified store with the job title including a number of hours worked and a present number of employees with the job title that are employed by the specified store. The system also includes means for estimating future payroll metrics for the job title based on a programmatic execution of a second algorithm that receives as inputs a forecasted number of employees to hold the job title at the specified store and a forecasted number of hours for which employees with the job title are scheduled to work at the specified store, including full-time employees and part-time employees. The forecasted number of employees is based on adjusting the present number of employees with the job title by an attrition rate at the store for employees with the job title, and the forecasted number of hours employees with the job title are to be scheduled is based on a full-time or part-time status of the employee and addition of paid holidays. The system further includes means for estimating forecasted workforce metrics for the job title based on execution of a third algorithm that receives as inputs the future payroll metrics, a work schedule for the employees at the specified store with the job title, and a number of open requisitions for the job title for the specified store. The system includes means for determining preferred workforce metrics for a specified period of time for the job title including a preferred number of employees and a number of employee-hours that need to be worked to fulfill one or more tasks assigned to the job title, and means for determining whether an anticipated low-point in customer demand curve is expected within the specified period of time. The system further includes means for comparing the forecasted workforce metrics to the preferred workforce metrics to estimate an employee-hour deficit in workforce during the specified time period, means for generating a hiring recommendation for the job title based on the estimated employee-hour deficit and open requisitions for the job title where the hiring recommendation indicates a proposed work schedule for a new-hire, and means for programmatically assigning an employee status of full-time, part-time, or temporary to the hiring recommendation based on execution of conditional code which considers a temporal relationship between the estimated employee-hour deficit and the identified low-point in the customer demand curve.

### BRIEF DESCRIPTION OF DRAWINGS

Some embodiments are illustrated by way of example in the accompanying drawings and should not be construed to limit the present disclosure:

FIG. 1 is a block diagram showing a workforce recommendation tool implemented in modules, according to an example embodiment;

FIG. 2 is a flowchart showing an example method for generating a hiring recommendation based on current workforce information and future workforce needs, according to an example embodiment;

FIGS. 3A and 3B are flowcharts showing an example hiring process for a store, according to an example embodiment;

FIG. 4 depicts an example process for the workforce recommendation tool, according to an example embodiment;

FIG. 5 depicts an example user interface displaying a gap analysis for an employee-hour deficit, according to an example embodiment;

FIGS. 6A and 6B depict an example user interface displaying a hiring recommendation and a gap analysis for a job title, according to an example embodiment;

FIG. 7 illustrates a network diagram depicting a system for implementing the workforce recommendation tool, according to an example embodiment; and

FIG. 8 is a block diagram of an exemplary computing device that may be used to implement exemplary embodiments of the workforce recommendation tool described herein.

### DESCRIPTION OF EXEMPLARY EMBODIMENTS

Described in detail herein are systems, methods, and computer readable medium for generating a hiring recommendation based on current workforce information and future workforce needs via a workforce recommendation tool. Example embodiments provide for determining historical payroll metrics for a job title, estimating future payroll metrics for the job title, estimated forecasted workforce metrics for the job title, determining preferred workforce metrics for the job title, determining whether an anticipated low-point is expected within a specified period of time, comparing the forecasted workforce metrics and the preferred workforce metrics to estimate an employee-hour deficit in the workforce, generate a hiring recommendation for the job title, and assign an employment status to the hiring recommendation.

The workforce recommendation tool integrates data from a requisition management system and a scheduling system to provide information to store managers as they manage the hiring needs for their stores, by, for example, enabling pre-screening of candidates for their availability based on the store's hiring need. The workforce recommendation tool identifies coverage gaps in the work schedules of current employees, and identifies the need for hiring new employees for a specific job title and/or for a specific work schedule. These coverage gaps are also compared to financial metrics to ensure the new requisitions are affordable within the store's financial budget.

This information is presented to a user in the form of a decision support system to manage a store's hiring needs. The workforce recommendation tool presents hiring recommendations along with existing requisitions. The hiring recommendations are compared to financial metrics and the user is informed if the hiring recommendations are affordable per the store's budget. The user can review the scheduling gap analysis determined by the workforce recommendation tool for each job title to decide to keep or close a requisition or to open a different requisition.

Once requisitions are opened or closed, user can use the gap analysis provided by the workforce recommendation tool for a requisition to create a pre-screen guide to ensure candidates are being interviewed for a specific job title and specific work schedule that is compatible with the store's hiring needs. The workforce recommendation tool also enables hiring to be consistent with seasonal trends and to backfill in response to employee attrition more reliably based on financial metrics and scheduling coverage gaps. The pre-screen process ensures that job positions are fulfilled with appropriate candidates. The workforce recommendation tool aligns the hiring process with the financial metrics and critical coverage gaps of the store.

Workforce, as used herein, refers to persons engaged in or available for work at a store. Workforce may also be referred to as employees, staff, personnel, workers, labor force, human resources, manpower, and the like. Workforce metrics, as used herein, refers to data related to an employed workforce at a store, for example, schedules of employees, job title of employees, employee status, and the like. Employee status, as used herein, refers to the employment status of an employee based on, for example, the minimum number of hours the employee is hired to work (e.g., part-time, full-time) and/or the duration of time for which the employee is hired (e.g., temporary, permanent).

The following description is presented to enable any person skilled in the art to create and use a computer system configuration and related method and article of manufacture to generate a hiring recommendation based on current workforce information and future workforce needs. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

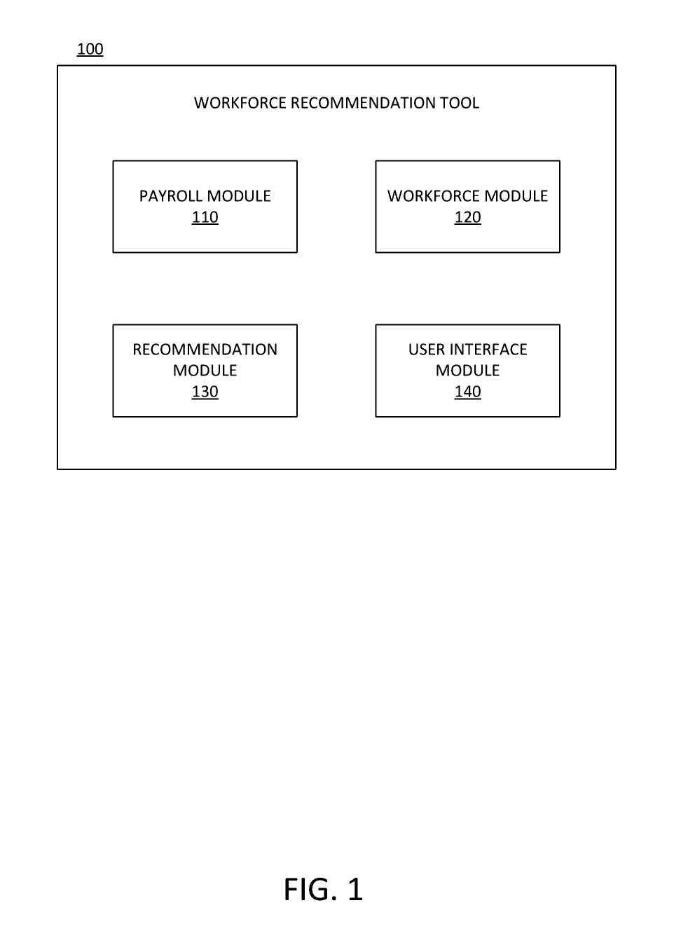

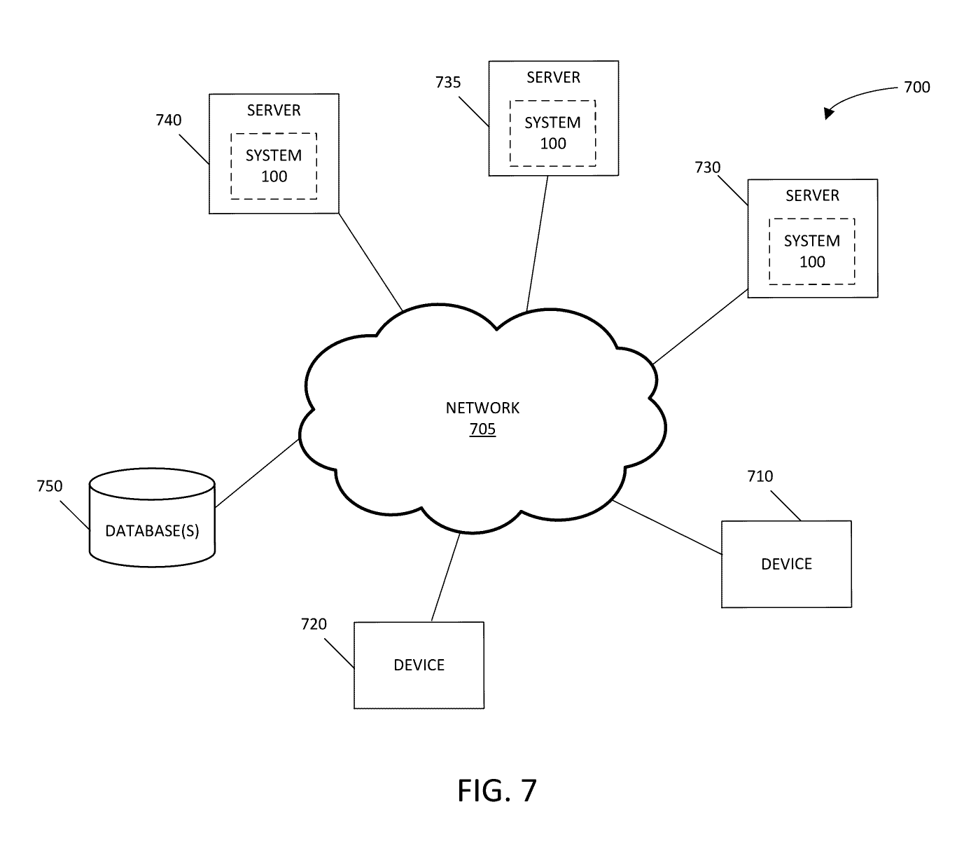

FIG. 1 is a block diagram 100 showing a workforce recommendation tool in terms of modules according to an example embodiment. The modules may be implemented in devices 710, 720 shown in FIG. 7 The modules include a payroll module 110, workforce module 120, recommendation module 130, and user interface module 140. The modules may include various circuits, circuitry and one or more software components, programs, applications, apps or other units of code base or instructions configured to be executed by one or more processors included in devices 710, 720. In other embodiments, one or more of modules 110, 120, 130, 140 may be included in servers 730, 735, 740 while other of the modules 110, 120, 130, 140 are provided in the device 710, 720. Although modules 110, 120, 130, and 140 are shown as distinct modules in FIG. 1, it should be understood that modules 110, 120, 130, and 140 may be implemented as fewer or more modules than illustrated. It should be understood that any of modules 110, 120, 130, and 140 may communicate with one or more components included in system 700 (FIG. 7), such as database(s) (e.g., database(s) 750), servers (e.g., servers 730, 735, 740), or devices (e.g., devices 710, 720).

The payroll module 110 may be configured to manage and analyze payroll data related to various job titles at a store to determine payroll metrics for a job title. The payroll data may include data related to pay rate for employees for a job title, number of employees for a job title, employee status (full-time, part-time, temporary), number of hours an employee is scheduled to work, number of hours an employee actually worked, paid holidays in a calendar year, and the like. The payroll module 110 may be configured to determine historical payroll metrics and estimate future payroll metrics. The payroll module 110 is also the means for determining historical payroll metrics for a job title associated with a specified store based on programmatic execution of a first algorithm that receives as inputs payroll data for employees working at the specified store with the job title including a number of hours worked and a present number of employees with the job title that are employed by the specified store. The payroll module 110 is also the means for estimating future payroll metrics for the job title based on a programmatic execution of a second algorithm that receives as inputs a forecasted number of employees to hold the job title at the specified store and a forecasted number of hours for which employees with the job title are scheduled to work at the specified store, including full-time employees and part-time employees, where the forecasted number of employees is based on adjusting the present number of employees with the job title by an attrition rate at the store for employees with the job title, and where the forecasted number of hours employees with the job title are to be scheduled is based on a full-time or part-time status of the employee and addition of paid holidays.

The workforce module 120 may be configured to manage and analyze workforce data related to various job titles at a store. The workforce data may include data related to a work schedule for employees for a job title, a preferred number of employees for a job title, number of employee-hours required for a job title, number of open requisitions for a job title, and the like. The workforce module 120 may be configured to estimate forecasted workforce metrics and determine preferred workforce metrics. The workforce module 120 is also the means for estimating forecasted workforce metrics for the job title based on execution of a third algorithm that receives as inputs the future payroll metrics, a work schedule for the employees at the specified store with the job title, and a number of open requisitions for the job title for the specified store. The workforce module 120 is also the means for determining preferred workforce metrics for a specified period of time for the job title including a preferred number of employees and a number of employee-hours that need to be worked to fulfill one or more tasks assigned to the job title. The workforce module 120 is also the means for determining whether an anticipated low-point in customer demand curve is expected within the specified period of time, and for comparing the forecasted workforce metrics to the preferred workforce metrics to estimate an employee-hour deficit in workforce during the specified time period.

The recommendation module 130 may be configured to manage and analyze hiring data. The hiring data may include data related to open requisitions for a job title, recommendation for new requisition for a job title, work schedule for new requisition for a job title, employee status for new requisition, and the like. The recommendation module 130 is also the means for generating a hiring recommendation for the job title based on the estimated employee-hour deficit and open requisitions for the job title, the hiring recommendation indicating a proposed work schedule for a new-hire. The recommendation module 130 is also the means for programmatically assigning an employee status of full-time, part-time, or temporary to the hiring recommendation based on execution of conditional code which considers a temporal relationship between the estimated employee-hour deficit and the identified low-point in the customer demand curve.

The user interface module 140 may be configured to manage and display information on a user interface. The user interface may include information related to employee-hour deficit in the workforce, a number of required employee-hours, a number of actual employee hours, a number of forecasted employee hours, recommendation for new requisitions, and the like.

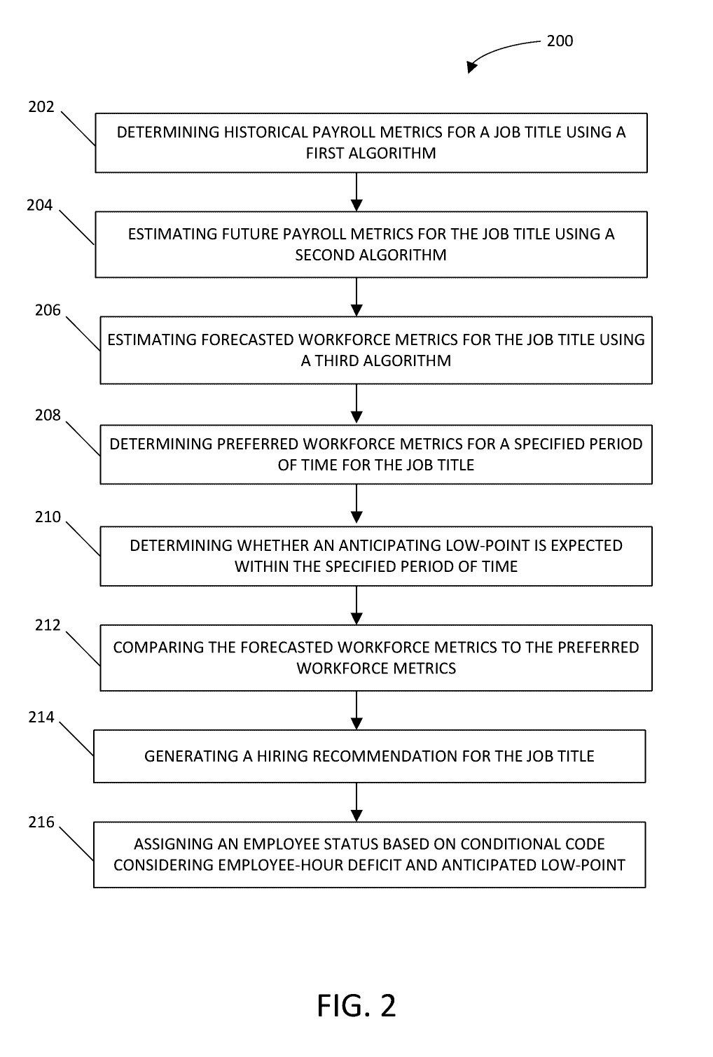

FIG. 2 is a flow chart showing an example method 200 for generating a hiring recommendation based on current workforce information and future workforce needs. The method 200 may be performed using the modules in the workforce recommendation tool 100 shown in FIG. 1.

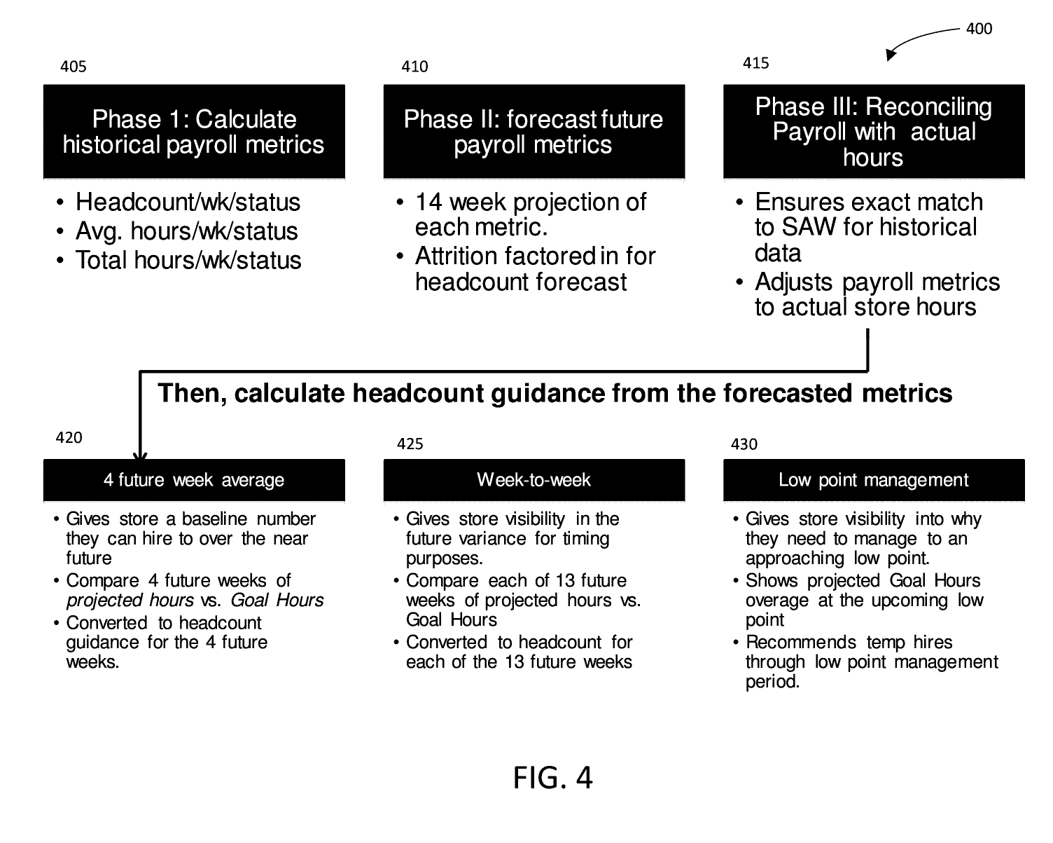

In operation 202, the payroll module 110 determines historical payroll metrics for a job title using a first algorithm. The first algorithm receives as inputs payroll data for employees working at the specified store with the job title including a number of hours worked and a present number of employees with the job title that are employed by the specified store. An example of the first algorithm is provided herein in connection with FIG. 4.

In an example embodiment, the payroll module 110 retrieves payroll data from a database storing data related to payroll information for a plurality of employees. The payroll data may include at least a number of hours worked by employees for each job title and a present number of employees employed for each job title. The payroll data may be stored in a database for a payroll system separate from the workforce recommendation tool.

In operation 204, the payroll module 110 estimates future payroll metrics for the job title using a second algorithm. The second algorithm receives as inputs a forecasted number of employees to hold the job title at the specified store and a forecasted number of hours for which employees with the job title are scheduled to work at the specified store. The forecasted number of employees includes full-time employees and part-time employees, and the forecasted number of employees is based on adjusting the present number of employees with the job title by an attrition rate at the specified store for employees with the job title. The forecasted number of hours employees with the job title are to be scheduled is based on a full-time or part-time status of the employee and addition of paid holidays. An example of the second algorithm is provided herein in connection with FIG. 4.

In operation 206, the workforce module 120 estimates forecasted workforce metrics for the job title using a third algorithm. The third algorithm receives as inputs the future payroll metrics, a work schedule for the employees at the specified store with the job title, and a number of open requisitions for the job title for the specified store. Future payroll metrics can be defined as total hours forecasted to work for all of the full time employees, part time employees, and temp employees for a store for a specified time period, for example, 14 weeks. The forecasted total hours may be calculated as Forecasted Average Hours per associate over the specified time period multiplied by Forecasted Headcount (e.g., a number of employees scheduled to work) for the specified time period. The forecasted workforce metrics are based on a budget for a specified store for which the metrics are to be generated.

In an example embodiment, the forecasted workforce metrics is calculated for a specified period of 14 weeks in the future.

In operation 208, the workforce module 120 determines preferred workforce metrics for a specified period of time for the job title. The preferred workforce metrics includes a preferred number of employees and a number of employee-hours that need to be worked to fulfill one or more tasks assigned to the job title. Preferred workforce metric can be defined by goal hours which can be determined by financial organizations within a business, and can be provided as a budget target for a specified store to schedule employees in the future. Future goal hours are retrieved from a database for each week for a store. Goal hours may not be dependent on the employee status or job title. Preferred workforce metrics are based on forecasted workload to complete tasks required for operating a store.

In an example embodiment, the workforce module 120 retrieves scheduling data from a database storing data related to scheduling information for a plurality of job titles. The retrieved scheduling data may include at least a number of hours employees are scheduled to work for each job title, and a work schedule including day and time of a week for the employees for each job title. The scheduling data may be stored in database for a scheduling system separate from the workforce recommendation tool.

In operation 210, the workforce module 120 determines whether an anticipated low-point in customer demand curve is expected within the specified period of time. The low-point in customer demand may be based on a seasonal or regional low-point in customer demand. Each store may have a different low-point based on its geographic location and/or customer base. The low-point for a store can be defined as the lowest amount of actual hours worked in a store over a period of 53 weeks. The low-point corresponds to the minimum amount of staffing needed to support a store. Managing to a low-point enables a store to schedule full-time employees for consistent work hours, and helps prevent overstaffing during the slowest customer demand for the store. In the event a store is approaching a low-point, hiring of temp employees rather full-time or part-time employees benefits the store as temp employees do not have an employment commitment as the store approaches the low-point.

In operation 212, the workforce module 120 compares the forecasted workforce metrics to the preferred workforce metrics to estimate an employee-hour deficit in workforce during the specified time period. This step may also be referred herein as the gap analysis.

In operation 214, the recommendation module 130 generates a hiring recommendation for the job title. The hiring recommendation is based on the estimated employee-hour deficit and open requisitions for the job title, and indicates a work schedule for the new-hire.

In an example embodiment, the recommendation module 130 retrieves requisition data from a database storing data related to open requisitions for a store. The requisition data may include at least a number of open requisitions for each job title. The requisition data may be stored in a database for a hiring system separate from the workforce recommendation tool.

In an example embodiment, the recommendation module 130 generates a plurality of hiring recommendations for various job titles based on the employee-hour deficit and/or an identified low-point in customer demand curve. The plurality of hiring recommendations may be prioritized or ranked based on the employee-hour deficit to enable the manager to make a better decision. For example, a hiring recommendation for a job title with the larger employee-hour deficit may be ranked higher than a hiring recommendation for a job title with a smaller employee-hour deficit.

In operation 216, the recommendation module 130 assigns an employee status of full-time, part-time, or temporary to the hiring recommendation based on execution of conditional code which considers a temporal relationship between the estimated employee-hour deficit and the identified low-point in the customer demand curve. For example, the conditional code determines when a store is approaching a low-point, and recommends hiring of new employees accordingly.

In an example embodiment, a temporary employee status is assigned to the hiring recommendation upon execution of the conditional code when the estimated employee-hour deficit precedes the identified low point in the customer demand curve. That is, if there is gap in the workforce when the store is approaching a low-point, the workforce recommendation tool recommends hiring a temporary employee, rather than permanent employees, to help fill the gap in the workforce. Hiring temporary employees approaching a low-point enables a store to manage its workforce near a low-point. During a low-point, a store usually requires less employees to meet the lower than average customer demand. Prior to a low-point, a store may not want to hire many permanent employees because these employees may not be needed during the low-point. The workforce recommendation tool recognizes this concern, and recommends hiring temporary employees to decrease a gap in workforce prior to a low-point in customer demand curve, while allowing a natural reduction of workforce as the low-point approaches or is reached.

In an example embodiment, the recommendation module 130 assigns a permanent full-time or part-time employee status to the hiring recommendation upon execution of the conditional code when the estimated employee-hour deficit is estimated to occur after the identified low point in the customer demand curve.

In an example embodiment, the method 200 may include generating, via the user-interface module 140, a graphical representation of the employee-hour deficit for each job title. The user interface module 140 may also display the graphical representation, and the number of goal hours for a week and the number of hours employees are scheduled for the week. The graphical representation of the employee-hour deficit may be a time-series graph, and the graphical representation may indicate an employee-hour deficit in morning work hours and evening work hours. This feature allows a user to easily determine which work shift, morning shift or evening shift, for which an employee is needed. The user interface module 140 may also receive an input indicating user-selection of the hiring recommendation for a job title, and display the graphical representation of the employee-hour deficit for the job title in response to receiving the input.

In an example embodiment, the method 200 may include recalculating the forecasted workforce metrics based on the addition of a new requisition by a user. The user interface module 140 may receive an input indicating that a new requisition is opened for a job title. The workforce module 120 recalculates the forecasted workforce metrics based on the addition of the new requisition. The user-interface module 140 updates the graphical representation of the employee-hour deficit for the job title based on comparing the recalculated forecasted workforce metrics and the preferred workforce metrics. In this manner, the workforce recommendation tool enables a user to analyze the effect of adding a new requisition on the gap analysis in the workforce.

In some embodiments, the user is presented with a questionnaire to enable a user to input specific factors for a job title that are not considered by the workforce recommendation tool already. This feature allows for user-input in determining a hiring recommendation. The questionnaire allows a store manager flexibility in choosing a job title based on the store's needs, regardless of the system's recommendations. For example, the store manager may be aware that a cashier is planning on taking a leave-of-absence, however, the workforce recommendation tool may not be aware of this anticipated vacancy. The workforce recommendation tool may not recommend hiring of cashiers, but the store manager knows that a cashier needs to be hired for the store. Additionally, the store manager can modify the quantity for a particular hiring recommendation via the questionnaire.

In some embodiments, the workforce recommendation tool segments employees by their employee status (e.g., full-time, part-time, or temp) for certain steps of process described above. In some embodiments, the workforce recommendation tool segments employees by their job titles for certain steps of the process described above, for example, operation 214 of FIG. 2.

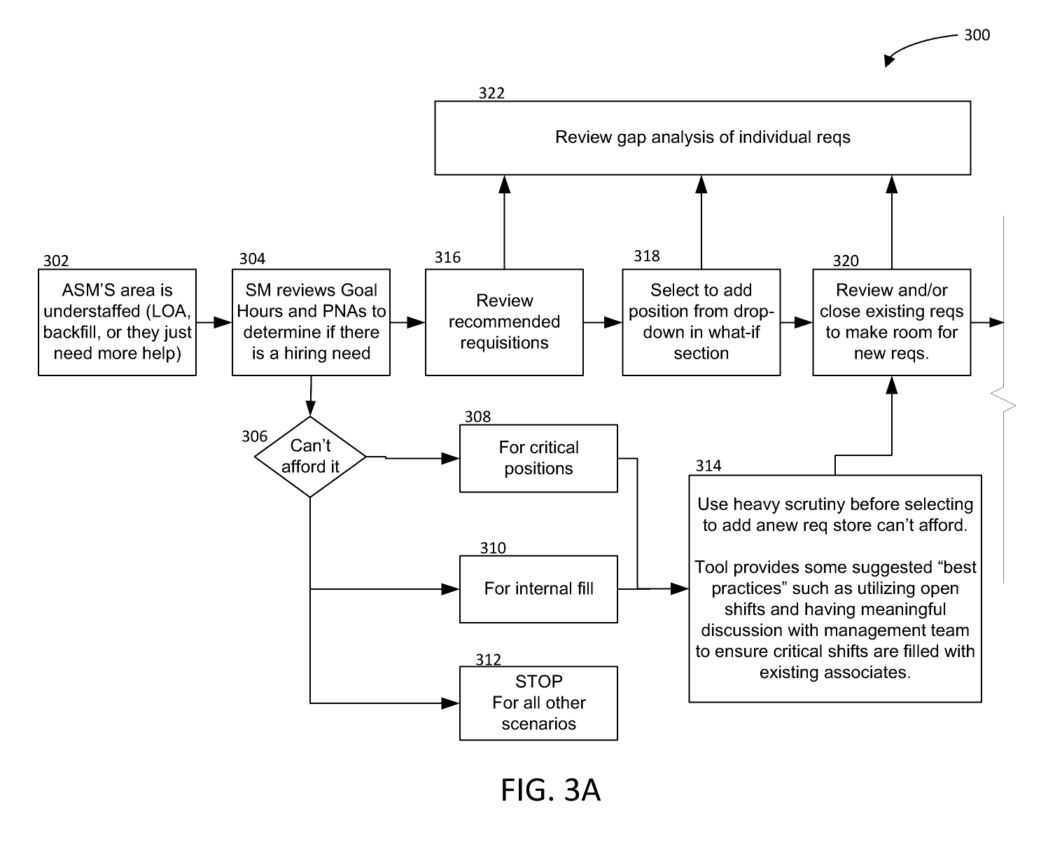

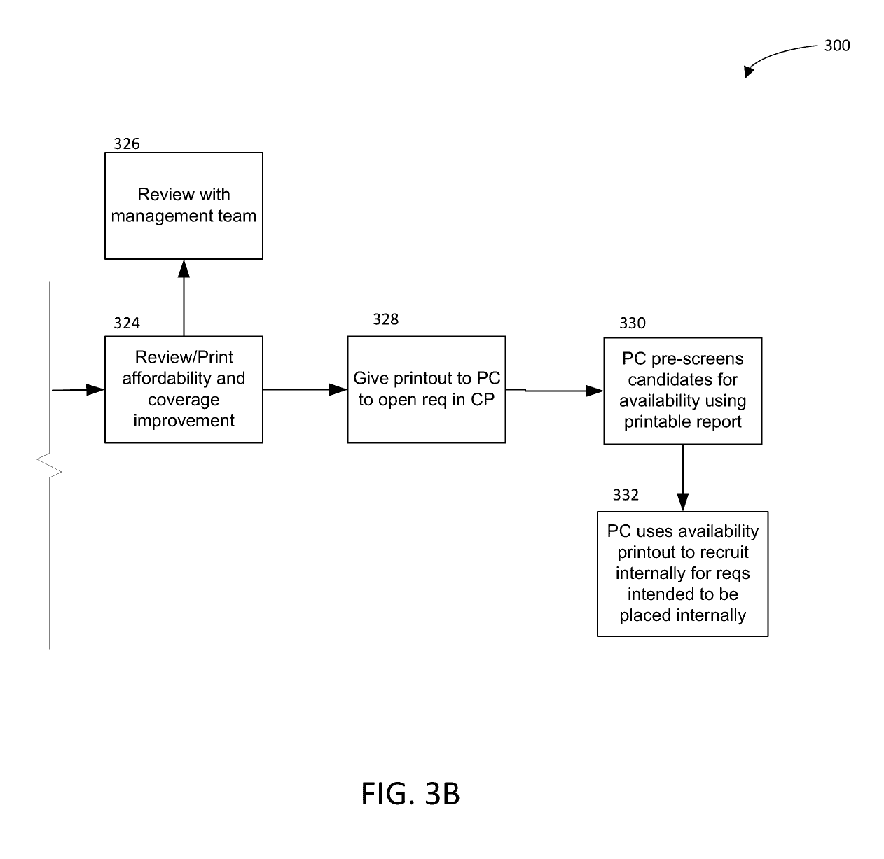

FIGS. 3A and 3B are flowcharts showing an example hiring process 300 for a store, according to an example embodiment. Process 300 begins at block 302, where an assistant store manager (ASM) realizes that his store area is understaffed due to leave-of-absence, backlog of work, or other reasons that requires hiring of more employees. At block 304, the store manager (SM) reviews goals hours and potential new associates (PNAs) via the workforce recommendation tool to determine if there is a hiring need. The system may use the term PNA to indicate shifts that went unfilled due to lack of an employee. If it is determined at block 306, that the store cannot afford to hire new employees based on the store's budget, then the process proceeds to one of three blocks. At block 308, the store manager can override the budget in the workforce recommendation tool for critical positions. At block 310, the store manager can request an internal fill to avoid spending over the budget, where an employee with another job title at the store is hired for the job title that needs a new-hire. At block 312, the process is stopped and a hiring recommendation is not generated. After either block 308 or 310, the process moves to block 314, where the workforce recommendation tool provides the store manager with information regarding “best practices” or other options for fulfilling the hiring needs for the store.

If the store can afford hiring new employees, then the process moves from block 304 to block 316. At block 316, the workforce recommendation tool displays the generated hiring recommendations to the store manager. At block 318, the store manager can select to add a requisition from the hiring recommendations to see the effect of hiring a new employee on the gap analysis. At block 320, the store manager can revise or close existing requisitions, if needed, to make space in the budget for opening new requisitions. At any of blocks 316, 318, and 320, the store manager can select a hiring recommendation and view the gap analysis (block 322) for the selected hiring recommendation. As described, the workforce recommendation tool displays a graphical representation of the gap analysis in response to a user input selecting a hiring recommendation in the user interface.

The process continues to block 324, shown in FIG. 3B. At block 324, the store manager, via the workforce recommendation tool, can review and print information related to affordability of a new employee and the improvement in the gap of employee hours resulting from hiring a new employee. This information can also be shared with the management team via the workforce recommendation tool at block 326.

After the store manager has decided to open a new requisition for a job title based on budget, payroll, and scheduling information for the job title, the store manager can instruct the human resources department to open the new requisition based on the work schedule indicated in the hiring recommendation (block 328). The human resources department can then easily screen candidates for the open requisition based on the candidates availability and the work schedule indicated in the hiring recommendation (block 330). The human resources department can also easily recruit from current employees, if the job is assigned for internal fill, based on the work schedule indicated in the hiring recommendation (block 332).

FIG. 4 depicts an example process 400 for the workforce recommendation tool, according to an example embodiment. At block 405, the historical payroll metrics are calculated using pay-period-ending (PPE) hours and headcount by employment status as inputs. The PPE hours and headcount may be retrieved from a database storing payroll data. The PPE hours refers to the number of hours worked or logged per pay period. The pay period for a store may be biweekly. A PPE hours to week ratio is calculated using historical goal hours and the PPE hours. For example, the ratio may be calculated using the equation Ratio_{1,2}=G₁/Gₜₒₜₐₗ, G₂/Gₜₒₜₐₗ , where G₁ and G₂ are the number of goal hours for a first and second pay period respectively, and Gₜₒₜₐₗ is the number of total goal hours for both pay periods. Next, the PPE hours are converted to weekly PPE hours using the equation weekly hours=PPE hours×Ratio. The average hours for a store is calculated based on the weekly hours and headcount by employment status. The output, at block 405, is historical average hours and headcount by employment status on a weekly basis for a job title at a store. The algorithm implemented at block 405 is an example of the first algorithm used to determine historical payroll metrics in operation 202 of FIG. 2.

At block 410, the future payroll metrics are forecasted using the historical average hours and headcount by employment status calculated at block 405. In some embodiments, payroll data for 2 years for the store is used to calculate the historical average hours to provide the forecasted future payroll metrics. Using a time series model, the average hours for a job title over 14 weeks into the future is forecasted. The forecasted average hours are capped at 40 hours for full-time status employees and 20 hours for part-time status employees, plus 20% of hours to account for paid holidays. The headcount for a job title is forecasted based on the current headcount adjusted for an average attrition rate for the job title for the employment status at the store. The output, at block 410, is forecasted total hours=forecasted headcount×forecasted average hours. The algorithm implemented at block 410 is an example of the second algorithm used to estimate future payroll metrics at block 204 in FIG. 2.

If payroll data is not available for 2 years for the store, then the historical average hours for such store is calculated based on a regional seasonal trend for the area the store is located in. Then, the forecasted total hours is calculated. In this manner, a store that does not have enough payroll data to forecast future payroll metrics, can still estimate future payroll metrics for a job title based on the regional trend in historical payroll metrics.

In some embodiments, the average hours for temporary employees for forecasting future payroll metrics are calculated using the following method. A weekly difference between the part-time employee historical average hours and the temporary employee historical average hours is calculated. The difference is applied to the part-time employee historical average hours per week. The forecasted average hours are capped at 34 hours, plus 20% for paid holidays.

At block 415, the calculated payroll metrics are reconciled with actual payroll metrics using historical average hours and headcount for a store for a week. An hour-percentage of total hours for full-time, part-time and temporary employees is calculated. The hour-percentage is applied to the weekly actual hours (obtained based on the number of hours actually worked by employees at a store) to determine actual hours for full-time employees, part-time employees, and temporary employees. Then, an actual average hour per headcount is calculated for full-time employees, part-time employees and part-time employees.

After the payroll metrics are forecasted, the headcount for a job title is forecasted based on attrition rate and historical headcount data. At block 420, a future-weeks average is determined (e.g., the next four weeks) and provided to a user for a comparison of forecasted employee hours and goal hours for a job title. At block 425, a week to week report for a specified number of future weeks (e.g., 13 weeks) is determined and provided to a user to compare each of the specified number of future weeks in terms of forecasted employee hours and goal hours. At block 430, a low-point in customer demand curve is accounted for by providing a user with information regarding an upcoming low-point that a store has to manage. Due to the low-point, there may be an overage in goal hours during that period. This overage is shown to the user via the user interface. The hiring recommendation generated by the workforce recommendation tool recommends the hiring of temporary employees when a low-point is approaching.

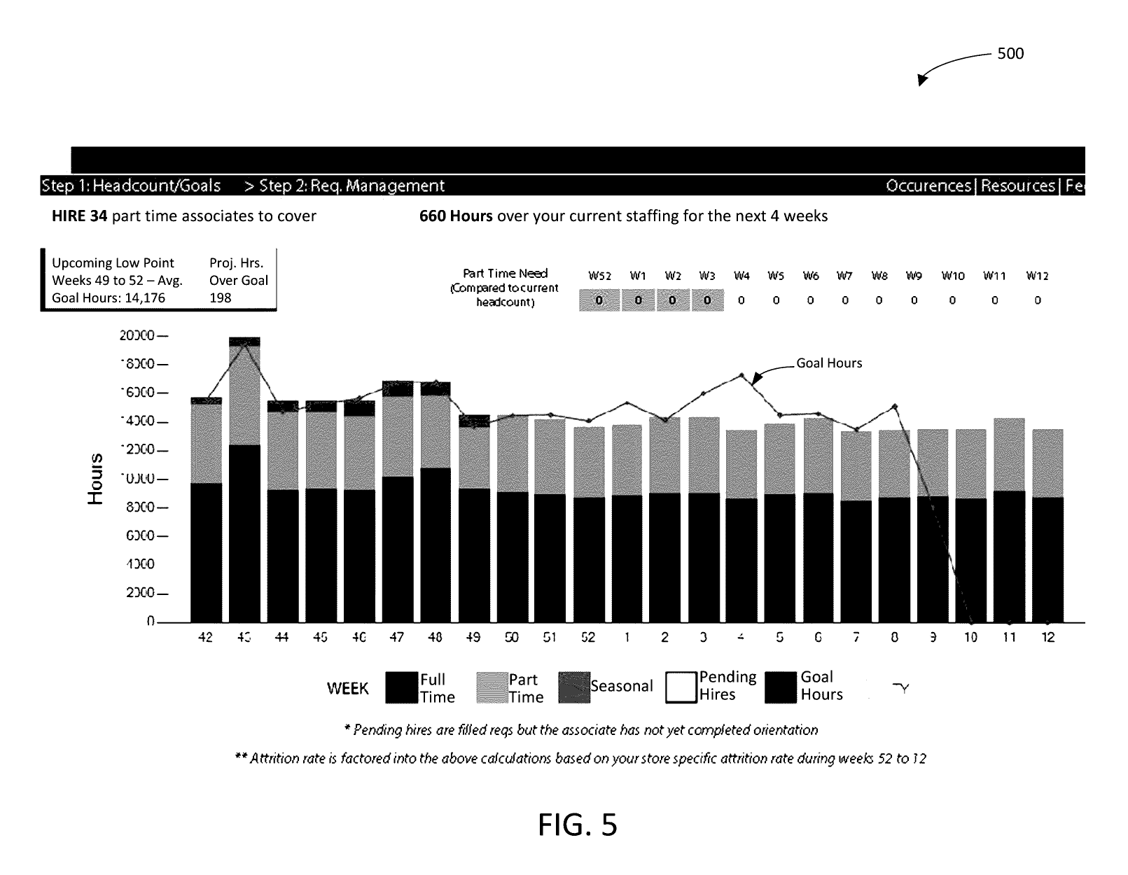

FIG. 5 depicts an example user interface 500 displaying an example gap analysis for an employee-hour deficit for a job title, according to an example embodiment. The user interface 500 provides a user with information for a specified period of time, here from week 14 to week 30 of the fiscal year, for a job title. The information is based on at least the various calculations performed with respect to historical payroll metrics, forecasted payroll metrics, employee goal hours, approaching low-point, and open requisitions. Using the information in user interface 500, a user, for example a store manager, can easily determine a gap in the number of employees hours and the goal hours for a job title. Additionally, the user can also view the gap between employee hours and goal hours for a future period. Thus, the user can easily make hiring decisions to manage the gap.

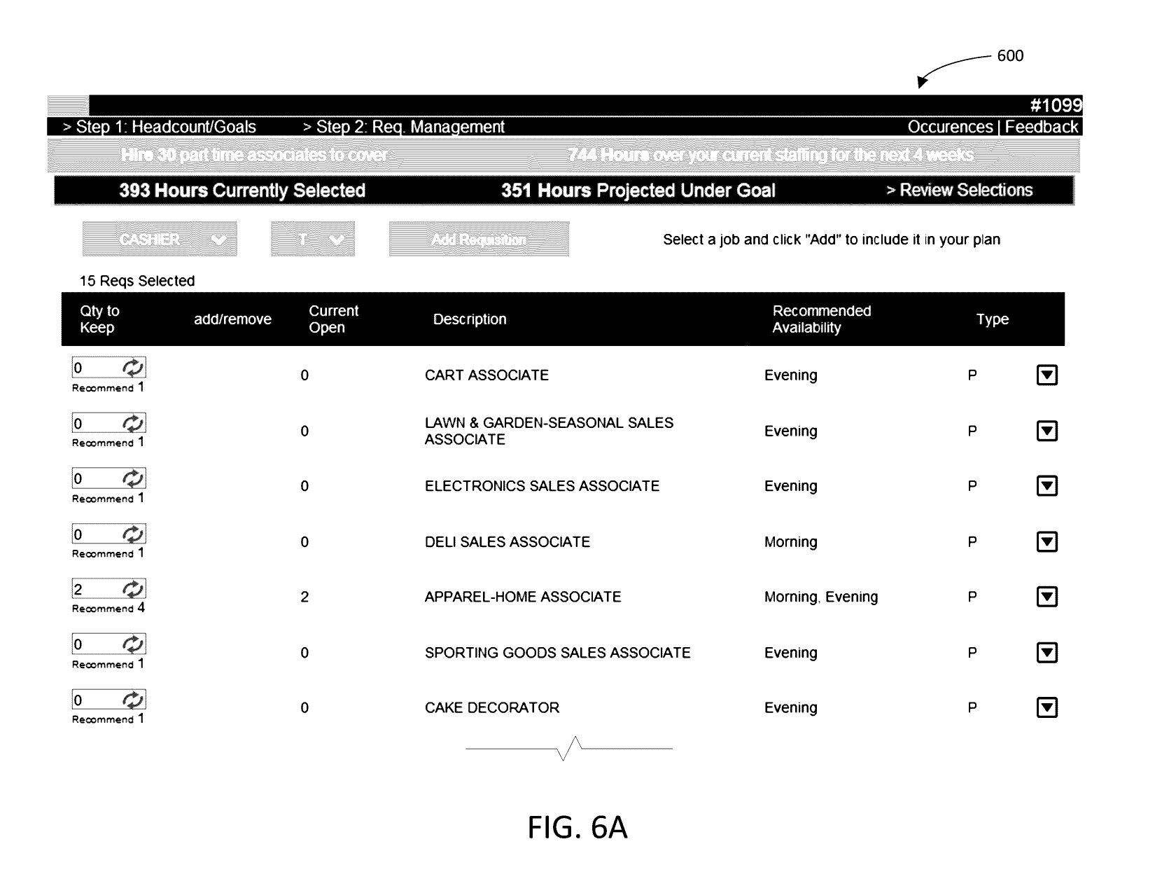

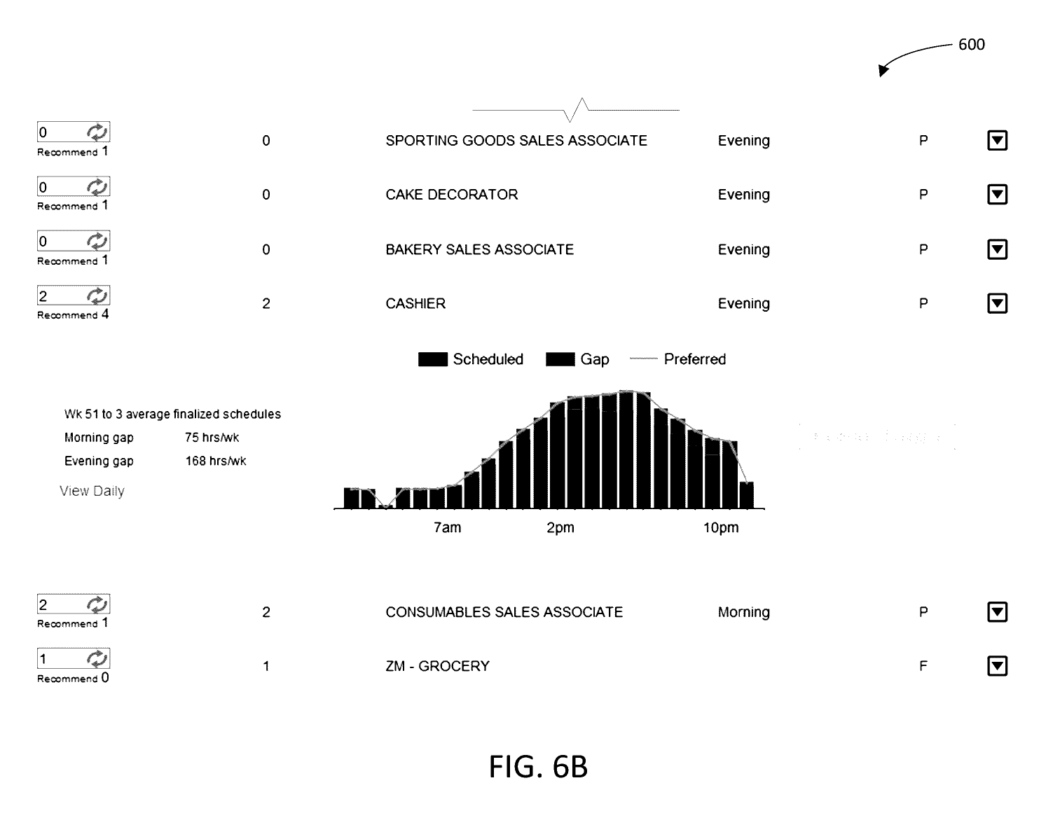

FIGS. 6A and 6B depict an example user interface 600 displaying a plurality of hiring recommendations and a gap analysis for a selected hiring recommendation for a job title, according to an example embodiment. The user interface 600 in FIG. 6A displays hiring recommendations for various job titles generated by the recommendation module 130. As described, the hiring recommendation indicates an employment status for the new-hire, for example ‘P’ indicating part-time status, and a preferred work schedule, for example evening shift or morning shift. The user interface 600 also displays information regarding already open requisitions for a job title. As described above and shown in FIG. 6B, the user interface module 140 displays a graphical representation of a gap analysis for a job title in response to a user selecting a hiring recommendation. Here, the user selected the job title “CASHIER”, and the gap analysis for CASHIER is displayed. As described, the gap analysis shows a comparison between the employee hours and goal hours for the job title. In this example, the gap analysis is shown for a work-day, and illustrates the gap in employee hours during a work-day. For example, as shown, there is a larger gap in employee hours during the evening shift, than the morning shift. Accordingly, the hiring recommendation indicates hiring of an employee for the CASHIER job title for the evening shift, as shown in FIG. 6B.

In this manner, the systems and methods described herein generate a hiring recommendation based on current workforce information and future workforce needs via the workforce recommendation tool. The workforce recommendation tool can enable a user to make efficient hiring decisions that align with a store's budget and employee-gap in schedules. It also enables a store to recruit and hire appropriate candidates based on their availability for a specific job title and a specific work schedule that is determined based on the store's hiring needs. The workforce recommendation tool also enables a user to consider seasonal trends in customer demand for a store when making hiring decisions.

FIG. 7 illustrates a network diagram depicting a system 700 for implementing the workforce recommendation tool, according to an example embodiment. The system 700 can include a network 705, multiple devices, for example, device 710, device 720, multiple servers, for example, server 730, server 735, server 740, and a database(s) 750. Each of the devices 710, 720, servers 730, 735, 740, and database(s) 750 is in communication with the network 705.

In an example embodiment, one or more portions of network 705 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The devices 710,720 may comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like.

Each of devices 710, 720 may connect to network 705 via a wired or wireless connection. Each of devices 710, 720 may include one or more applications such as, but not limited to, a work scheduling application, a payroll application, a budget application, a requisitions application, the workforce recommendation tool 100, and the like. In an example embodiment, the devices 710, 720 may perform all the functionalities described herein.

In other embodiments, the workforce recommendation tool may be included on the device 710, 720, and the servers 730, 735, 740 performs the functionalities described herein. In yet another embodiment, the device 710, 720 may perform some of the functionalities, and servers 730, 735, 740 performs the other functionalities described herein.

Each of the database(s) 750, and servers 730, 735, 740 is connected to the network 705 via a wired connection. Alternatively, one or more of the database(s) 750, and servers 730, 735, 740 may be connected to the network 705 via a wireless connection. Although not shown, server 730, 735, 740 can be (directly) connected to the database(s) 750. Servers 730, 735, 740 comprises one or more computers or processors configured to communicate with devices 710, 720 via network 705. Servers 730, 735, 740 hosts one or more applications or websites accessed by devices 710, 720 and/or facilitates access to the content of database(s) 750. Database(s) 750 comprise one or more storage devices for storing data and/or instructions (or code) for use by servers 730, 735, 740, and/or devices 710, 720. Database(s) 750, and/or servers 730, 735, 740, may be located at one or more geographically distributed locations from each other or from devices 710, 720. Alternatively, database(s) 750 may be included within servers 730, 735, 740.

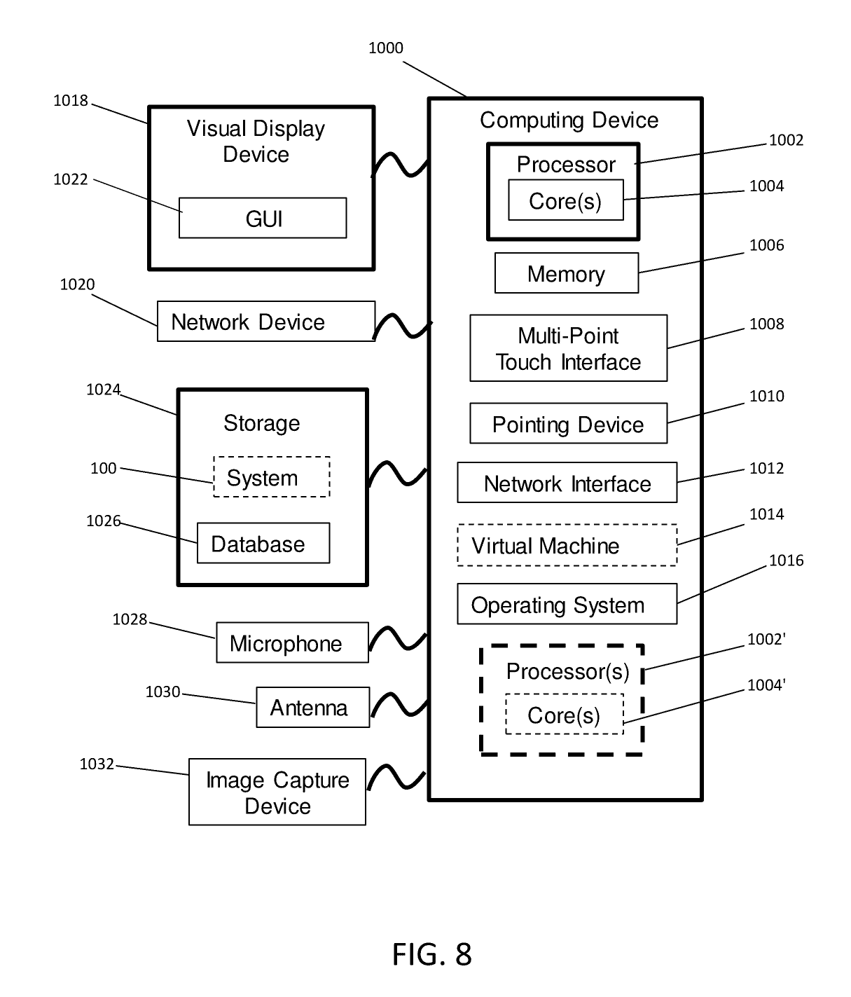

FIG. 8 is a block diagram of an exemplary computing device 1000 that may be used to implement exemplary embodiments of the workforce recommendation tool 100 described herein. The computing device 1000 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 1006 included in the computing device 1000 may store computer-readable and computer-executable instructions or software for implementing exemplary embodiments of the workforce recommendation tool 100. The computing device 1000 also includes configurable and/or programmable processor 1002 and associated core 1004, and optionally, one or more additional configurable and/or programmable processor(s) 1002′ and associated core(s) 1004′ (for example, in the case of computer systems having multiple processors/cores), for executing computer-readable and computer-executable instructions or software stored in the memory 1006 and other programs for controlling system hardware. Processor 1002 and processor(s) 1002′ may each be a single core processor or multiple core (1004 and 1004′) processor.

Virtualization may be employed in the computing device 1000 so that infrastructure and resources in the computing device may be shared dynamically. A virtual machine 1014 may be provided to handle a process running on multiple processors so that the process appears to be using only one computing resource rather than multiple computing resources. Multiple virtual machines may also be used with one processor.

Memory 1006 may include a computer system memory or random access memory, such as DRAM, SRAM, EDO RAM, and the like. Memory 1006 may include other types of memory as well, or combinations thereof.

A user may interact with the computing device 1000 through a visual display device 1018, such as a computer monitor, which may display one or more graphical user interfaces 1022 that may be provided in accordance with exemplary embodiments. The computing device 1000 may include other I/O devices for receiving input from a user, for example, a keyboard or any suitable multi-point touch interface 1008, a pointing device 1010 (e.g., a mouse), a microphone 1028, and/or an image capturing device 1032 (e.g., a camera or scanner). The multi-point touch interface 1008 (e.g., keyboard, pin pad, scanner, touch-screen, etc.) and the pointing device 1010 (e.g., mouse, stylus pen, etc.) may be coupled to the visual display device 1018. The computing device 1000 may include other suitable conventional I/O peripherals.

The computing device 1000 may also include one or more storage devices 1024, such as a hard-drive, CD-ROM, or other computer readable media, for storing data and computer-readable instructions and/or software that implement exemplary embodiments of the workforce recommendation tool 1000 described herein. Exemplary storage device 1024 may also store one or more databases for storing any suitable information required to implement exemplary embodiments. For example, exemplary storage device 1024 can store one or more databases 1026 for storing information, such employee work schedules, payroll information, number of current employees, number of hours worked, number of hours scheduled, employment status, open requisitions, goal hours, low-point information, budget information, and/or any other information to be used by embodiments of the system 100. The databases may be updated manually or automatically at any suitable time to add, delete, and/or update one or more items in the databases.

The computing device 1000 can include a network interface 1012 configured to interface via one or more network devices 1020 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing device 1000 can include one or more antennas 1030 to facilitate wireless communication (e.g., via the network interface) between the computing device 1000 and a network. The network interface 1012 may include a built-in network adapter, network interface card, PCMCIA network card, card bus network adapter, wireless network adapter, USB network adapter, modem or any other device suitable for interfacing the computing device 1000 to any type of network capable of communication and performing the operations described herein. Moreover, the computing device 1000 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 1000 may run any operating system 1016, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 1016 may be run in native mode or emulated mode. In an exemplary embodiment, the operating system 1016 may be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A method for generating a metric based on current information and future needs, the method comprising:
determining, by a payroll module, historical payroll metrics for a job title associated with a specified store based on programmatic execution, by the payroll module, of a first algorithm that receives as inputs payroll data for employees working at the specified store with the job title including a number of hours worked and a present number of employees with the job title that are employed by the specified store;
estimating, by the payroll module, future payroll metrics for the job title based on a programmatic execution, by the payroll module, of a second algorithm that receives as inputs a forecasted number of employees to hold the job title at the specified store and a forecasted number of hours for which employees with the job title are scheduled to work at the specified store, including full-time employees and part-time employees, wherein the forecasted number of employees is based on adjusting the present number of employees with the job title by an attrition rate at the store for employees with the job title, and wherein the forecasted number of hours employees with the job title are to be scheduled is based on a full-time or part-time status of the employee and addition of paid holidays;
estimating, by a workforce module, forecasted workforce metrics for the job title based on execution, by the workforce module, of a third algorithm that receives as inputs the future payroll metrics, a work schedule for the employees at the specified store with the job title, and a number of open requisitions for the job title for the specified store;
determining, by the workforce module, preferred workforce metrics for a specified period of time for the job title including a preferred number of employees and a number of goal hours indicating employee-hours that need to be worked to fulfill one or more tasks assigned to the job title;
determining, by the workforce module, whether an anticipated low-point in customer demand curve is expected within the specified period of time;
comparing, by the workforce module, the forecasted workforce metrics to the preferred workforce metrics to estimate an employee-hour deficit in workforce during the specified time period;
generating, by a recommendation module, a hiring recommendation for the job title based on the estimated employee-hour deficit and open requisitions for the job title, the hiring recommendation indicating a proposed work schedule for a new-hire; and
programmatically assigning, by the recommendation module, an employee status of full-time, part-time, or temporary to the hiring recommendation based on execution, by the recommendation module, of conditional code which considers a temporal relationship between the estimated employee-hour deficit and the identified low-point in the customer demand curve.

2. The method of claim 1, wherein a temporary employee status is assigned to the hiring recommendation upon execution of the conditional code when the estimated employee-hour deficit precedes the identified low point in the customer demand curve.

3. The method of claim 1, wherein a permanent or part-time employee status is assigned to the hiring recommendation upon execution of the conditional code when the estimated employee-hour deficit is estimated to occur after the identified low point in the customer demand curve.

4. The method of claim 1, wherein the forecasted workforce metrics is calculated for a period of 14 weeks in the future.

5. The method of claim 1, further comprising:
retrieving, by the workforce module, scheduling data from a database storing data related to scheduling information for a plurality of job titles, the scheduling data including at least a number of hours employees are scheduled to work for each job title, and a work schedule including day and time of a week for the employees for the job title;
retrieving, by the payroll module, payroll data from a database storing data related to payroll information for a plurality of employees, the payroll data including at least a number of hours worked by employees for each job title and a present number of employees employed for the job title; and
retrieving, by the recommendation module, requisition data from a database storing data related to open requisitions for a store, the requisition data including at least a number of open requisitions for the job title.

6. The method of claim 1, further comprising:
generating, by a user-interface module, a graphical representation of the employee-hour deficit for each job title; and
displaying, by the user-interface module, the graphical representation, and the number of goal hours for a week and the number of hours employees are scheduled for the week.

7. The method of claim 6, wherein the graphical representation of the employee-hour deficit is a time-series graph, and the graphical representation indicates a employee-hour deficit in morning work hours and a employee-hour deficit in evening work hours.

8. The method of claim 6, further comprising:
receiving, by the user-interface module, input indicating user-selection of the hiring recommendation for a job title; and
in response to receiving the input, displaying, by the user-interface module, the graphical representation of the employee-hour deficit for the job title.

9. The method of claim 6, further comprising:
receiving, by the user-interface module, an input indicating that a new requisition is opened for a job title;
recalculating, by the workforce module, the forecasted workforce metrics based on the addition of the new requisition; and
updating, by the user-interface module, the graphical representation of the employee-hour deficit for the job title based on comparing the recalculated forecasted workforce metrics and the preferred workforce metrics.

10. A system for generating a metric based on current information and future needs, the system comprising:
a memory; and
a processor configured to execute instructions stored in the memory, causing the system to:
determine historical payroll metrics for a job title associated with a specified store based on programmatic execution of a first algorithm that receives as inputs payroll data for employees working at the specified store with the job title including a number of hours worked and a present number of employees with the job title that are employed by the specified store;
estimate future payroll metrics for the job title based on a programmatic execution of a second algorithm that receives as inputs a forecasted number of employees to hold the job title at the specified store and a forecasted number of hours for which employees with the job title are scheduled to work at the specified store, including full-time employees and part-time employees, wherein the forecasted number of employees is based on adjusting the present number of employees with the job title by an attrition rate at the store for employees with the job title, and wherein the forecasted number of hours employees with the job title are to be scheduled is based on a full-time or part-time status of the employee and addition of paid holidays;
estimate forecasted workforce metrics for the job titles based on execution of a third algorithm that receives as inputs the future payroll metrics, a work schedule for the employees at the specified store with the job title, and a number of open requisitions for the job title for the specified store;
determine preferred workforce metrics for a specified period of time for the job title including a preferred number of employees and a number of employee-hours that need to be worked to fulfill one or more tasks assigned to the job title;
determine whether an anticipated low-point in customer demand curve is expected within the specified period of time;
compare the forecasted workforce metrics to the preferred workforce metrics to estimate an employee-hour deficit in workforce during the specified time period;
generate a hiring recommendation for the job title based on the estimated employee-hour deficit and open requisitions for the job title, the hiring recommendation indicating a proposed work schedule for a new-hire; and
programmatically assign an employee status of full-time, part-time, or temporary to the hiring recommendation based on execution of conditional code which considers a temporal relationship between the estimated employee-hour deficit and the identified low-point in the customer demand curve.

11. The system of claim 10, wherein a temporary employee status is assigned to the hiring recommendation upon execution of the conditional code when the estimated employee-hour deficit precedes the identified low point in the customer demand curve.

12. The system of claim 10, wherein a permanent or part-time employee status is assigned to the hiring recommendation upon execution of the conditional code when the estimated employee-hour deficit is estimated to occur after the identified low point in the customer demand curve.

13. The system of claim 10, wherein the processor is further configured to execute instructions causing the system to:
retrieve scheduling data from a database storing data related to scheduling information for a plurality of job titles, the scheduling data including at least a number of hours employees are scheduled to work for each job title, and a work schedule including day and time of a week for the employees for each job title;
retrieve payroll data from a database storing data related to payroll information for a plurality of employees, the payroll data including at least a number of hours worked by employees for each job title and a present number of employees employed for each job title; and
retrieve requisition data from a database storing data related to open requisitions for a store, the requisition data including at least a number of open requisitions for each job title.

14. The system of claim 10, wherein the processor is further configured to execute instructions causing the system to:
generate a graphical representation of the employee-hour deficit for each job title; and
display the graphical representation, and the number of goal hours for a week and the number of hours employees are scheduled for the week.

15. The system of claim 14, wherein the graphical representation of the employee-hour deficit is a time-series graph, and the graphical representation indicates an employee-hour deficit in morning work hours and an employee-hour deficit in evening work hours.

16. The system of claim 14, wherein the processor is further configured to execute instructions causing the system to:
receive input indicating user-selection of the hiring recommendation for a job title from the plurality of job titles; and
in response to receiving the input, display the graphical representation of the employee-hour deficit for the job title.

17. A non-transitory machine-readable medium storing instructions executable by a processing device, wherein execution of the instructions causes the processing device to implement a method for generating a metric based on current information and future needs, the method comprising:
determining historical payroll metrics for a job title associated with a specified store based on programmatic execution of a first algorithm that receives as inputs payroll data for employees working at the specified store with the job title including a number of hours worked and a present number of employees with the job title that are employed by the specified store;
estimating future payroll metrics for the job title based on a programmatic execution of a second algorithm that receives as inputs a forecasted number of employees to hold the job title at the specified store and a forecasted number of hours for which employees with the job title are scheduled to work at the specified store, including full-time employees and part-time employees, wherein the forecasted number of employees is based on adjusting the present number of employees with the job title by an attrition rate at the store for employees with the job title, and wherein the forecasted number of hours employees with the job title are to be scheduled is based on a full-time or part-time status of the employee and addition of paid holidays;
estimating forecasted workforce metrics for the job titles based on execution of a third algorithm that receives as inputs the future payroll metrics, a work schedule for the employees at the specified store with the job title, and a number of open requisitions for the job title for the specified store;
determining preferred workforce metrics for a specified period of time for the job title including a preferred number of employees and a number of employee-hours that need to be worked to fulfill one or more tasks assigned to the job title;
determining whether an anticipated low-point in customer demand curve is expected within the specified period of time;
comparing the forecasted workforce metrics to the preferred workforce metrics to estimate an employee-hour deficit in workforce during the specified time period;
generating a hiring recommendation for the job title based on the estimated employee-hour deficit and open requisitions for the job title, the hiring recommendation indicating a proposed work schedule for a new-hire; and
programmatically assigning an employee status of full-time, part-time, or temporary to the hiring recommendation based on execution of conditional code which considers a temporal relationship between the estimated employee-hour deficit and the identified low-point in the customer demand curve.

18. The non-transitory machine-readable medium of claim 17, wherein a temporary employee status is assigned to the hiring recommendation upon execution of the conditional code when the estimated employee-hour deficit precedes the identified low point in the customer demand curve.

19. The non-transitory machine-readable medium of claim 17, wherein a permanent or part-time employee status is assigned to the hiring recommendation upon execution of the conditional code when the estimated employee-hour deficit is estimated to occur after the identified low point in the customer demand curve.

20. The non-transitory machine-readable medium of claim 17, further comprising:
generating a graphical representation of the employee-hour deficit for each job title; and
displaying the graphical representation, and the number of goal hours for a week and the number of hours employees are scheduled for the week.

21. A system for generating a metric based on current information and future needs, the system comprising:
means for determining historical payroll metrics for a job title associated with a specified store based on programmatic execution of a first algorithm that receives as inputs payroll data for employees working at the specified store with the job title including a number of hours worked and a present number of employees with the job title that are employed by the specified store;
means for estimating future payroll metrics for the job title based on a programmatic execution of a second algorithm that receives as inputs a forecasted number of employees to hold the job title at the specified store and a forecasted number of hours for which employees with the job title are scheduled to work at the specified store, including full-time employees and part-time employees, wherein the forecasted number of employees is based on adjusting the present number of employees with the job title by an attrition rate at the store for employees with the job title, and wherein the forecasted number of hours employees with the job title are to be scheduled is based on a full-time or part-time status of the employee and addition of paid holidays;
means for estimating forecasted workforce metrics for the job title based on execution of a third algorithm that receives as inputs the future payroll metrics, a work schedule for the employees at the specified store with the job title, and a number of open requisitions for the job title for the specified store;
means for determining preferred workforce metrics for a specified period of time for the job title including a preferred number of employees and a number of employee-hours that need to be worked to fulfill one or more tasks assigned to the job title;
means for determining whether an anticipated low-point in customer demand curve is expected within the specified period of time;
means for comparing the forecasted workforce metrics to the preferred workforce metrics to estimate an employee-hour deficit in workforce during the specified time period;
means for generating a hiring recommendation for the job title based on the estimated employee-hour deficit and open requisitions for the job title, the hiring recommendation indicating a proposed work schedule for a new-hire; and
means for programmatically assigning an employee status of full-time, part-time, or temporary to the hiring recommendation based on execution of conditional code which considers a temporal relationship between the estimated employee-hour deficit and the identified low-point in the customer demand curve.
